(19) United States
(12) Patent Application Publication
(10) Pub. No.: US 2020/0017374 A1
(43) Pub. Date: Jan. 16, 2020

(54) ELECTROCHEMICAL ADSORBTION WITH GRAPHENE NANOCOMPOSITES

(71) Applicant: UTI LIMITED PARTNERSHIP, Calgray (CA)

(72) Inventors: Edward ROBERTS, Calgary (CA); Farbod SHARIF, Calgary (CA)

(73) Assignee: UITI Limited Partnership, Calgary, AB (CA)

(21) Appl. No.: 16/490,591

(22) PCT Filed: Mar. 2, 2018
(86) PCT No.: PCT/CA2018/050250

§ 371 Date: Sep. 2, 2019

Related U.S. Application Data
(60) Provisional application No. 62/466,263, filed on Mar. 2, 2017.

(51) Int. Cl. C02F 1/28; C02F 1/467; C02F 1/461; B01D 15/20; B01J 20/20; B01J 20/34

(52) U.S. Cl. CPC C02F 1/288; C02F 1/4672; C02F 1/46109; B01D 15/203; B01J 20/205; C02F 2101/308; B01J 20/3416; C02F 1/281; C02F 1/283; C02F 2305/08; C02F 2303/16; B01J 20/3441

(57) ABSTRACT

In alternative aspects, the invention provides processes for cyclic electrochemical adsorption of aqueous contaminants using nanocomposites of graphene with tin oxide or antimony doped tin oxide.

### FIELD OF THE INVENTION

The invention is in the field of adsorbent treatment of aqueous solutions, including processes that electrochemically regenerate graphene-based electrodes.

### BACKGROUND OF THE INVENTION

There are a wide variety of processes by which organic contaminants may be removed from aqueous solutions by adsorption. In some circumstances, it may be advantageous to regenerate the adsorbents for reuse. Various approached may be used for regeneration of adsorbents: thermal regeneration, chemical regeneration, wet air regeneration or electrochemical regeneration. Electrochemical regeneration has for example been applied to the use of graphite flake adsorbents (see for example WO 2011/058298). In such processes, important parameters include: adsorbent capacity, electrochemical regeneration rate, conductivity and degree of corrosion of the graphite adsorbent.

Anodes used for oxidation in water treatment are generally classified as active or non-active. Active anodes are active for oxygen evolution by oxidation of water, while non-active anodes are not active for oxygen evolution and generate hydroxide radicals which are effective for oxidation of organic pollutants. Graphite is generally categorized as an active anode, its functionalization with non-active materials may lead to increased hydroxyl radical production and thereby facilitate high rates of contaminant degradation. For example, modification of a graphite electrode with boron doped diamond and TiO₂ particles has been reported to increase the degradation rate of organics through electrochemical oxidation (Wang et al., 2008).

Adsorption and electrochemical oxidation of reduced graphene oxide (RGO), and RGO/iron oxide nanocomposites has been characterized as showing complete regeneration, high current efficiency and good adsorptive capacity compared to graphite adsorbent (Sharif et al., 2017). However, in these processes graphene may be corroded in the course of the regeneration process. This phenomenon has also been observed with graphite flake during electrochemical regeneration (Nkrumah-Amoako et al., 2014). The corrosion of an adsorbent electrode may be a significant problem over multiple cycles of adsorption and electrochemical regeneration.

### SUMMARY OF THE INVENTION

In alternative aspects, the invention provides processes for cyclic electrochemical adsorption of aqueous contaminants using nanocomposites of graphene with tin oxide or antimony doped tin oxide.

In some embodiments, graphene-based adsorbents are provided that may be readily regenerated. Select adsorbents have high surface areas, nonporous surfaces and the electrical conductivity of graphene. In some embodiments, these nanocomposite adsorbents may for example be used with magnetic iron oxide materials, so that the adsorbents may be separated from treated water.

In one aspect, a process is provided for treating a liquid, such as an aqueous liquid, comprising:
contacting the liquid with a solid adsorbent nanocomposite of graphene with tin oxide (TO) or antimony doped tin oxide (ATO), so that a contaminant in the liquid, such as an organic compound, is adsorbed onto the nanocomposite to provide a treated liquid; and,
passing a current through the nanocomposite to regenerate the nanocomposite by electrochemical conversion of the adsorbed contaminant so as to remove the contaminant from the nanocomposite and thereby provide a regenerated nanocomposite.

To carry out the process, an electrolytic cell may accordingly be provided that includes:

a nonconductive housing containing a conductive liquid electrolyte comprising a contaminant;

an anode disposed in the electrolyte within the housing, comprising an adsorbent nanocomposite of graphene with tin oxide (TO) or antimony doped tin oxide (ATO), wherein the contaminant adsorbs onto the nanocomposite;

a cathode disposed in the electrolyte within the housing, so that the electrolyte provides conductivity between the anode and the cathode; and,

a current source connecting the anode and the cathode, configured to supply a current between the anode and the cathode and thereby electrochemically convert adsorbed contaminant so as to remove the contaminant from the nanocomposite.

The electrochemical conversion may involve electrochemical oxidation of the contaminant, and the current may for example be in the range of 3-50 mA per cm² of a current feeder for the nanocomposite, for example a graphite current feeder supporting a bed of the nanocomposite, for example a bed from about 0.2 mm to 2 mm thick. A salt may for example be added to the bed of nanocomposite, such as NaCl or Na₂SO₄. The process may be a batch treatment process, or a continuous treatment process, and may further involve contacting the liquid with the regenerated nanocomposite, for example in a plurality of cycles of contacting the liquid and regenerating the nanocomposite, so that the liquid is repeatedly contacted with the regenerated nanocomposite.

### BRIEF DESCRIPTION OF THE DRAWINGS

FIG. 1 is a graph illustrating the effect of regeneration time on regeneration efficiency of MB on 0.1 g of graphene or graphene TiO₂ composite by applying the current density of 10 mA/cm².

FIG. 2 is a bar graph illustrating regeneration efficiency over number of adsorption and electrochemical regeneration cycles for MB adsorption on bare graphene, TO/graphene 7, TO/graphene 13, ATO/graphene 7, A TO/graphene 13.

### DETAILED DESCRIPTION OF THE INVENTION

As disclosed herein, tin oxide (TO) and antimony tin oxide (ATO) graphene nanocomposites have been synthesized, characterized and used as adsorbents in adsorption and electrochemical regeneration processes. The nanocomposites are exemplified using alternative TO and ATO loading characteristics: 7 and 13 wt % TO or ATO. Methylene blue (MB) solution is used as a model synthetic wastewater. The advantageous electrochemical regeneration properties of these materials are exemplified, including regeneration time required for 100% regeneration, current efficiency and performance with multiple cycles of adsorption and regeneration. Regeneration was carried out in an electrolytic cell at a constant current of 0.11 A, corresponding to 10 mA per cm² of adsorbent bed, with a graphite plate anode current feeder and stainless steel cathode. A sodium chloride solution was used as the electrolyte.

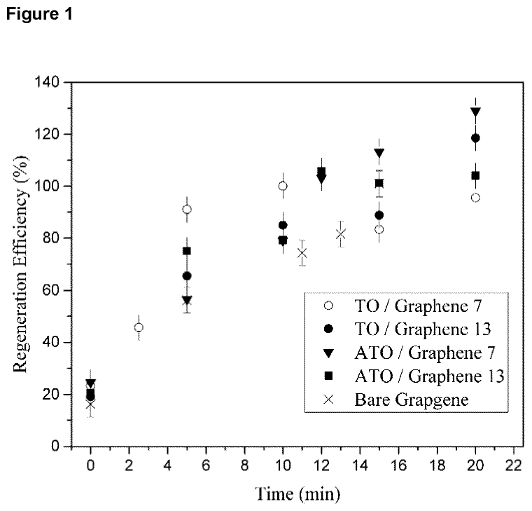

The regeneration efficiency behavior of each adsorbent at the different oxidation times is presented at FIG. 1. All of the adsorbents demonstrate complete regeneration ability. The regeneration efficiency increased with increasing regeneration time, until 100% regeneration is achieved for all adsorbents. The time required for 100% regeneration may be estimated from the data in FIG. 1. The characteristics of the adsorption/regeneration process with 100% regeneration are shown in Table 1.

TABLE 1
Electrochemical regeneration performance of bare graphene, TiO2/
Graphene 400, TO/Graphene 7, TO/Graphene 13, ATO/Graphene 7, ATO/
Graphene 13 adsorbents for regeneration at 10 mA cm⁻²

| | | TiO₂/ | | | | |
|---|---|---|---|---|---|---|
| | Graphene | Graphene 400 | TO/Graphene 7 | TO/Graphene 13 | ATO/Graphene 7 | ATO/Graphene 13 |
| Regeneration time (min) | 14 | 7 | 11 | 16 | 12 | 12 |
| Adsorptive capacity (mg g⁻¹) | 24 | 22 | 31 | 31 | 29.5 | 29.5 |
| Current density (mA cm⁻²)- | 10 | 10 | 10 | 10 | 10 | 10 |
| surface area (cm⁻²) | 11 | 11 | 11 | 11 | 11 | 11 |
| Current efficiency (%) | 79 | 136 | 136 | 93 | 111 | 116 |
| Cell voltage (V) | 2.6 | 3.0 | 2.6 | 2.6 | 2.6 | 2.6 |

Surprisingly the adsorption capacity of TO and ATO graphene nanocomposites was higher than graphene. Further, although the amount of adsorbed MB on TO and ATO nanocomposites was higher than bare graphene, the required regeneration time was less. Current efficiency is a powerful tool to compare the actual and theoretical charge needed for complete mineralization of the organics in the course the regeneration, i.e. higher current efficiency leads to lower energy consumption. The current efficiency for the electrochemical regeneration of the nanocomposites was significantly higher (ca. 1.5 times) than for graphene. These results illustrate that the exemplified metal oxide nanoparticles offer high electrocatalytic oxidation rates for organics.

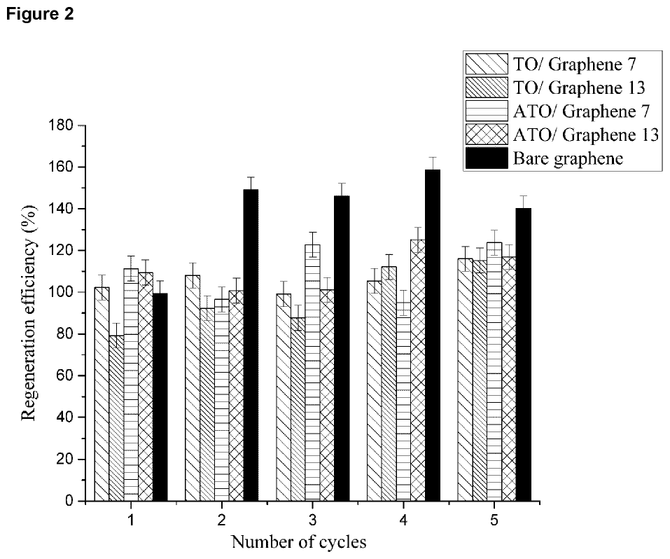

The durability of the nanocomposites was illustrated through cyclic adsorption and regeneration processes. The nanocomposites were applied in 5 consecutive adsorption regeneration cycles. Due to oxidation of graphene, surface area of the graphene increased, therefore the adsorptive capacity and consequently the regeneration efficiency of bare graphene increased. However, as illustrated in FIG. 2, changes in adsorptive capacity and the regeneration efficiency of all synthesized nanocomposites even after 5 cycles were small, indicating that the tin oxide nanocomposite is not corroding during regeneration. The higher regeneration efficiency observed with the graphene indicates corrosion leading to an increase in the adsorption capacity. In addition, with the graphene adsorbent the treated water became cloudy after five or more cycles, indicating that particles of adsorbent were released due to corrosion.

In accordance with the exemplified embodiments, nanocomposites of graphene with tin oxide (TO) or antimony doped tin oxide (ATO) can be used for treatment of aqueous solutions by adsorption with anodic electrochemical regeneration. These materials may be adapted for use in process that have a number of advantages. For example, graphene based materials of the invention may be provided that have a higher surface area, and hence a higher adsorptive capacity, compared to graphite based adsorbents. In addition, the preparation of TO and ATO graphene nanocomposites is facile and does not require heat treatment at high temperatures, and unlike TiO₂ graphene nanocomposites which needs to be annealed at 400° C. Typically, the as prepared metal oxide sol was mixed with graphene particles for 24 h and then dried at 70° C. for 12 h (Guo et al., 2015).

In some aspects of the invention, graphene TO and ATO nanocomposites may be provided that have a higher adsorptive capacity than pure graphene. In addition, the cell voltage for select TO and ATO graphene nanocomposites may be lower than is required for other graphene nanocomposites, leading to a lower energy use during regeneration. In some embodiments, the current efficiency of select TO and ATO nanocomposites may be significantly higher than that for alternative materials, such as pure graphene, leading to lower energy consumption for regeneration. Finally, in contrast to pure graphene, the nanocomposites of the invention have been shown to be stable over multiple cycles of adsorption and regeneration.

### REFERENCES

Guo, X., et al. (2015). “Preparation and electrochemical property of TiO2/Nano-graphite composite anode for electro-catalytic degradation of ceftriaxone sodium.” Electrochimica Acta 180: 957-964.

Nkrumah-Amoako, K., et al. (2014). “The effects of anodic treatment on the surface chemistry of a Graphite Intercalation Compound.” Electrochimica Acta 135: 568-577.

Sharif, F., et al. (2017). “Electrochemical regeneration of a reduced graphene oxide/magnetite composite adsorbent loaded with methylene blue.” Water Research, volume 114, Pages 237-245.

Wang, L., et al. (2008). “The influence of TiO2 and aeration on the kinetics of electrochemical oxidation of phenol in packed bed reactor.” Journal of Hazardous Materials 160(2-3): 608-613.

### Conclusion

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

1. A process for treating a liquid, comprising:
contacting the liquid with a solid adsorbent nanocomposite of graphene with tin oxide (TO) or antimony doped tin oxide (ATO), so that a contaminant in the liquid is adsorbed onto the nanocomposite to provide a treated liquid; and,
passing a current through the nanocomposite to regenerate the nanocomposite by electrochemical conversion of the adsorbed contaminant so as to remove the contaminant from the nanocomposite and thereby provide a regenerated nanocomposite.

2. The process of claim 1, wherein the liquid is aqueous and the contaminant is an organic compound.

3. The process of claim 1 or 2, wherein the electrochemical conversion comprises electrochemical oxidation of the contaminant.

4. The process of any one of claims 1 to 3, wherein the current is 3-50 mA per cm² of a current feeder for the nanocomposite.

5. The process of claim 4, wherein the current is 5-15 mA per cm² of the current feeder.

6. The process of claim 4 or 5, wherein the current feeder is graphite, and a bed of the nanocomposite sits on the current feeder.

7. The process of claim 6, wherein the bed of the nanocomposite is from about 0.2 mm to 2 mm thick.

8. The process of claim 6 or 7, wherein a salt is added to the bed of nanocomposite.

9. The process of claim 8, wherein the salt is NaCl or Na₂SO₄.

10. The process of any one of claims 1 to 9, wherein the process is a batch treatment process.

11. The process of any one of claims 1 to 9, wherein the process is a continuous treatment process.

12. The process of any one of claims 1 to 11, wherein the process further comprises contacting the liquid with the regenerated nanocomposite.

13. The process of claim 12, wherein the process further comprises a plurality of cycles of contacting the liquid and regenerating the nanocomposite, so that the liquid is repeatedly contacted with the regenerated nanocomposite.

14. Use of an adsorbent nanocomposite of graphene with tin oxide (TO) or antimony doped tin oxide (ATO) to remove a contaminant from a liquid, wherein the nanocomposite is regenerable by passing a current through the nanocomposite to electrochemically convert adsorbed contaminant so as to remove the contaminant from the nanocomposite.

15. An electrolytic cell comprising:
a nonconductive housing containing a conductive liquid electrolyte comprising a contaminant;
an anode disposed in the electrolyte within the housing, comprising an adsorbent nanocomposite of graphene with tin oxide (TO) or antimony doped tin oxide (ATO), wherein the contaminant adsorbs onto the nanocomposite;
a cathode disposed in the electrolyte within the housing, so that the electrolyte provides conductivity between the anode and the cathode;
a current source connecting the anode and the cathode, configured to supply a current between the anode and the cathode and thereby electrochemically convert adsorbed contaminant so as to remove the contaminant from the nanocomposite.

16. The cell of claim 15, wherein the conductive liquid is aqueous and the contaminant is an organic compound.

17. The cell of claim 15 or 16, wherein the electrochemical conversion comprises electrochemical oxidation of the contaminant.

18. The cell of any one of claims 15 to 17, wherein the current is 3-50 mA per cm² of a current feeder for the nanocomposite.

19. The cell of claim 18, wherein the current is 5-15 mA per cm² of the current feeder.

20. The cell of claim 18 or 19, wherein the current feeder is graphite, and a bed of the nanocomposite sits on the current feeder.

21. The cell of claim 20, wherein the bed of the nanocomposite is from about 0.2 mm to 2 mm thick.

22. The cell of claim 20 or 21, wherein a salt is added to the bed of nanocomposite.

23. The cell of claim 22, wherein the salt is NaCl or Na₂SO₄.
